(19) United States
(12) Patent Application Publication
(10) Pub. No.: US 2025/0258361 A1
(43) Pub. Date: Aug. 14, 2025

(54) OPTICAL SYSTEM

(71) Applicant: SIGMA CORPORATION, Kanagawa (JP)

(72) Inventor: Hiroaki UEDA, Tokyo (JP)

(73) Assignee: SIGMA CORPORATION, Kanagawa (JP)

(21) Appl. No.: 18/788,727

(22) Filed: Jul. 30, 2024

(30) Foreign Application Priority Data
Feb. 14, 2024 (JP) 2024-020335

(51) Int. Cl. G02B 13/18; G02B 5/00; G02B 15/14

(52) U.S. Cl. CPC G02B 13/18; G02B 5/005; G02B 15/145115

(57) ABSTRACT

The optical system is configured to include a first lens group G1, a second lens group G2 with a positive refractive power, a third lens group G3, a fourth lens group G4 with a positive refractive power, and a fifth lens group G5 with a negative refractive power. When focusing from infinity to a close distance, the second lens group G2 and the fourth lens group G4 move to an object side through different paths along an optical axis, the second lens group G2 includes an aspherical lens G2asp having such a shape as to weaken a convex power from a center of the optical axis to a periphery, and the fourth lens group G4 includes one or more lenses each having at least a positive refractive power and one or more lenses each having at least a negative refractive power.

### FIELD OF INVENTION

The present invention relates to an optical system suitable for a lens to be used in an image capturing device such as a still camera or a video camera, a projection device, or the like, which is disposed as appropriate to contribute to a weight reduction, while effectively correcting various aberrations despite a large aperture ratio.

### BACKGROUND

In recent years, as the number of pixels in an image capturing device such as a digital still camera or a video camera has increased, there is a growing demand for higher optical performance provided by strongly correcting various aberrations from infinity to a close distance.

In addition, in recent digital cameras, focusing accuracy of autofocusing (hereinafter referred to as AF) has significantly improved, and consequently it has become possible to accurately focus even in a bright optical system with an extremely narrow depth of field. As a result, it is possible to shoot a video even at a maximum aperture, while maintaining accurate focus, which is greatly expanding a range of video expression. Therefore, there has been a demand for an optical system that suppresses field of view changes (hereinafter referred to as focus breathing) during a focusing operation even in the bright optical system.

Meanwhile, to achieve high descriptive performance from infinity to a close distance, a method in which two lens groups are moved with different paths during focus drive has been proposed thus far.

### SUMMARY OF INVENTION

In an optical system described in Japanese Patent Application Publication No. 2022-140076, focus groups are arranged in front of and behind a lens group including an aperture diaphragm and drive directions are caused to face each other to suppress changes in gravity center during focusing and suppress changes in AF speed due to an orientation difference. In addition, various aberrations from infinity to a close distance, including distortion, are satisfactorily corrected. However, when focusing from infinity to a close distance is performed, a lens group with a negative refractive power disposed on a further toward object side than the aperture diaphragm is moved to an image side, resulting in a problem of large focus breathing.

In an optical system described in WO 2021/241230, while various aberrations from infinity to a close distance, including distortion, are satisfactorily corrected, the focus breathing is also appropriately corrected. However, there is a problem in that the optical system is large and heavy.

The present invention has been made in view of such a situation, and an object thereof is to provide an optical system that is successfully reduced in size and weight by appropriately arranging a focus group and an aspherical surface, while satisfactorily correcting focus breathing and various aberrations including distortion despite a large aperture ratio.

To attain the object described above, an optical system implementing the present invention includes, in order from an object side: a first lens group G1, a second lens group G2 with a positive refractive power, a third lens group G3, a fourth lens group G4 with a positive refractive power, and a fifth lens group G5 with a negative refractive power, wherein, when focusing from infinity to a close distance, the second lens group G2 and the fourth lens group G4 move to the object side through different paths along an optical axis, the second lens group G2 includes an aspherical lens G2asp having such a shape as to weaken a convex power from a center of the optical axis to a periphery, and the fourth lens group G4 includes one or more lenses each having at least a positive refractive power and one or more lenses each having at least a negative refractive power.

In the optical system implementing the present invention, the fifth lens group G5 satisfies a following conditional expression (1), and the third lens group G3 includes a lens Lp with a positive refractive power simultaneously satisfying following conditional expressions (2) and (3):

$$1.1 < β G 5 < 1.6 \qquad ( 1 )$$

$$0.021 < Lp\_ΔPgF < 0.055 \qquad ( 2 )$$

$$1 / ( Lp\_f \times Lp\_vd ) < 0.0020 \qquad ( 3 )$$

where
βG5: a lateral magnification of the fifth lens group G5 when focusing on infinity,
Lp_ΔPgF: an anomalous partial dispersion ΔPgF of the lens Lp with the positive refractive power configured to be included in the third lens group G3,
Lp_vd: an abbe number vd of the lens Lp with the positive refractive power configured to be included in the third lens group G3, and
Lp_f: a focal length (mm) of the lens Lp with the positive refractive power configured to be included in the third lens group G3 when not joined.

In the optical system implementing the present invention, following conditional expressions are satisfied:

$$1. < f 2 / f 4 < 6. \qquad ( 4 )$$

$$( f 4 / vd\_G4ave ) / f < 0.050 \qquad ( 5 )$$

where
f: a focal length (mm) when focusing on infinity,
f2: a focal length (mm) of the second lens group G2 when focusing on infinity,
f4: a focal length (mm) of the fourth lens group G4 when focusing on infinity, and
vd_G4ave: an average value of abbe numbers vd of positive lenses included in the fourth lens group G4.

In the optical system implementing the present invention, the fifth lens group G5 includes an air lens AL configured including two adjacent lenses and satisfies the following conditional expression:

$$- 1. < ( R 2 air + R 1 air ) / ( R 2 air - R 1 air ) < 1. \qquad ( 6 )$$

where
R1air: an object-side curvature radius (mm) of the air lens AL configured to be included in the fifth lens group G5, and
R2air: an image-side curvature radius (mm) of the air lens AL configured to be included in the fifth lens group G5.

In the optical system implementing the present invention, a following conditional expression is satisfied:

$$0.0 \; 05 < \vert ( G 2 aspHnr - G 2 aspHinf ) / f\_G 2 \vert < 0. 050 \qquad ( 7 )$$

where
G2aspHinf: a ray height (mm) of an off-axis principal ray at an object side surface of the aspherical lens G2asp when focusing on infinity,
G2aspHnr: a ray height (mm) of the off-axis principal ray at the object side surface of the aspherical lens G2asp when focusing on a closest distance, the off-axis principal ray being a ray passing through a point of intersection of an aperture diaphragm with the optical axis at a largest angle of view, and
f2: a focal length (mm) of the second lens group G2 when focusing on infinity.

In the optical system implementing the present invention, the third lens group G3 has an aperture diaphragm S.

In the optical system implementing the present invention, the fourth lens group G4 includes an aspherical lens with a positive refractive power.

In the optical system implementing the present invention, the fifth lens group G5 includes an aspherical lens with a negative refractive power on a side thereof closest to an image.

According to the present invention, it is possible to provide an optical system successfully reduced in size and weight by appropriately arranging a focus group and an aspherical surface, while satisfactorily correcting focus breathing and various aberrations including distortion despite a large aperture ratio.

### BRIEF DESCRIPTION OF DRAWINGS

FIG. 1 is a lens cross-sectional view at infinity in an optical system in Example 1;

FIG. 2 is a longitudinal aberration diagram at infinity in the optical system in Example 1;

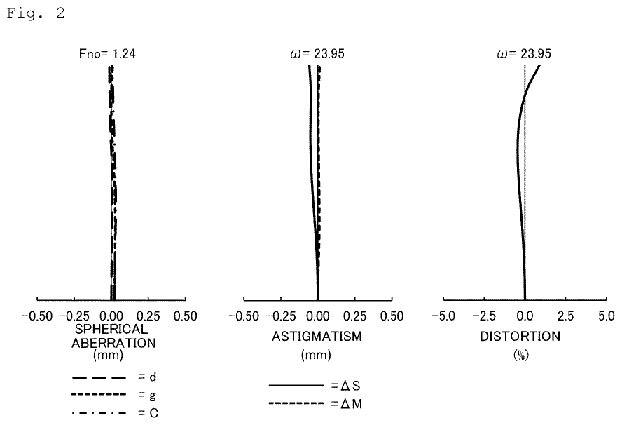

FIG. 3 is a longitudinal aberration diagram at a focusing distance of 395 mm in the optical system in Example 1;

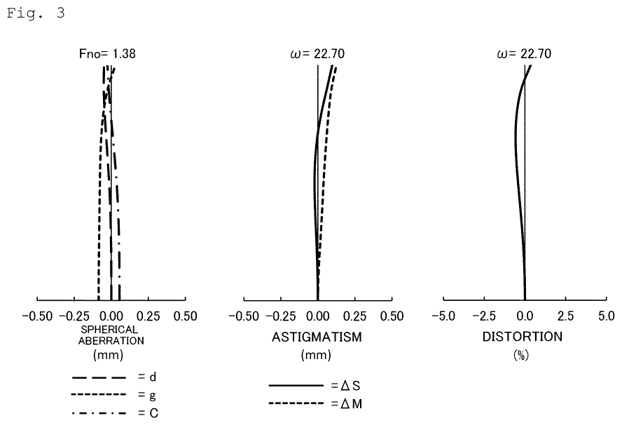

FIG. 4 is a lateral aberration diagram at infinity in the optical system in Example 1;

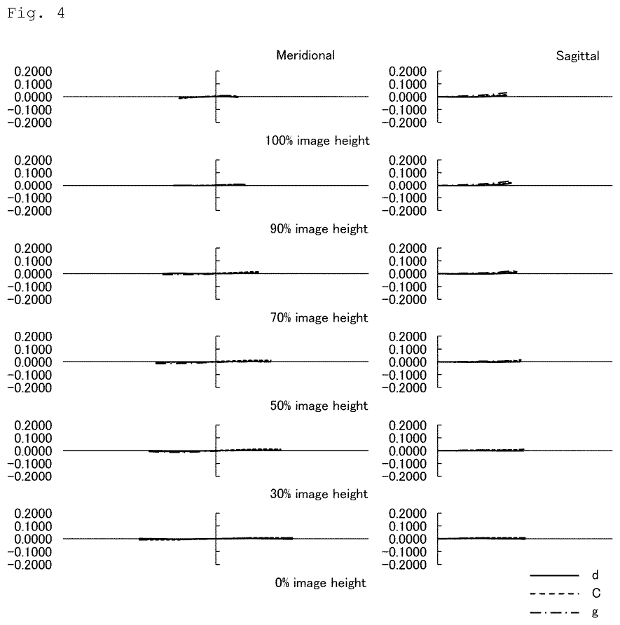

FIG. 5 is a lateral aberration diagram at a focusing distance of 395 mm in the optical system in Example 1;

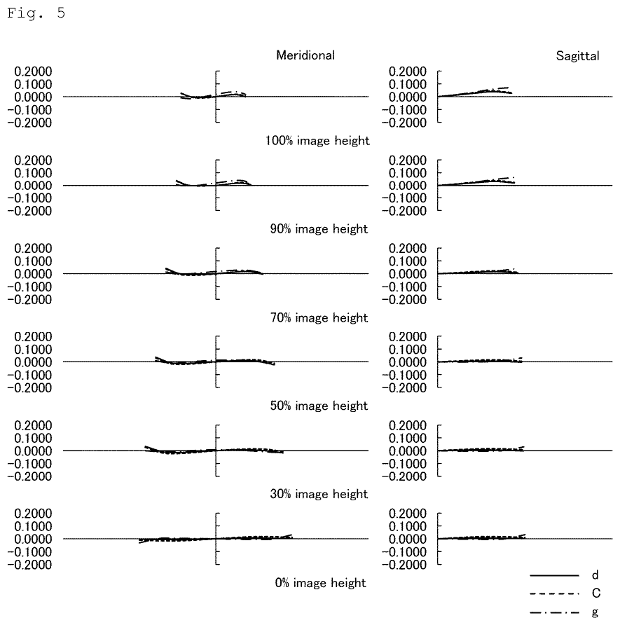

FIG. 6 is a lens cross-sectional view at infinity in an optical system in Example 2;

FIG. 7 is a longitudinal aberration diagram at infinity in the optical system in Example 2;

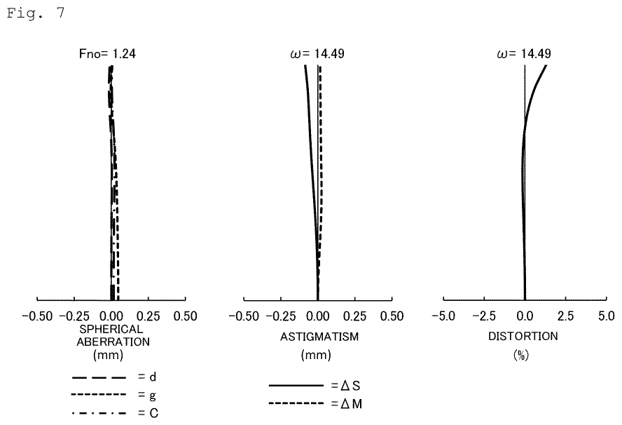

FIG. 8 is a longitudinal aberration diagram at a focusing distance of 832 mm in the optical system in Example 2;

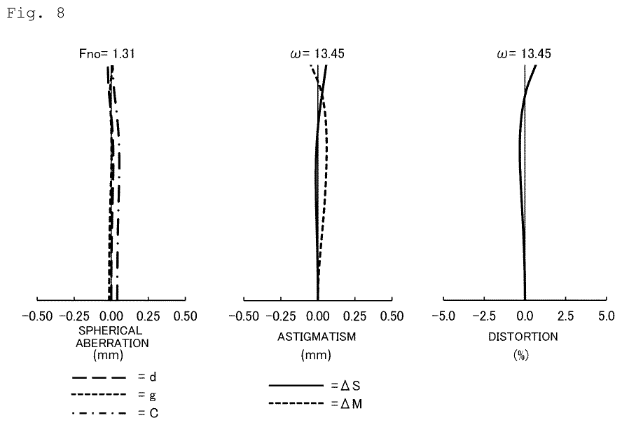

FIG. 9 is a lateral aberration diagram at infinity in the optical system in Example 2;

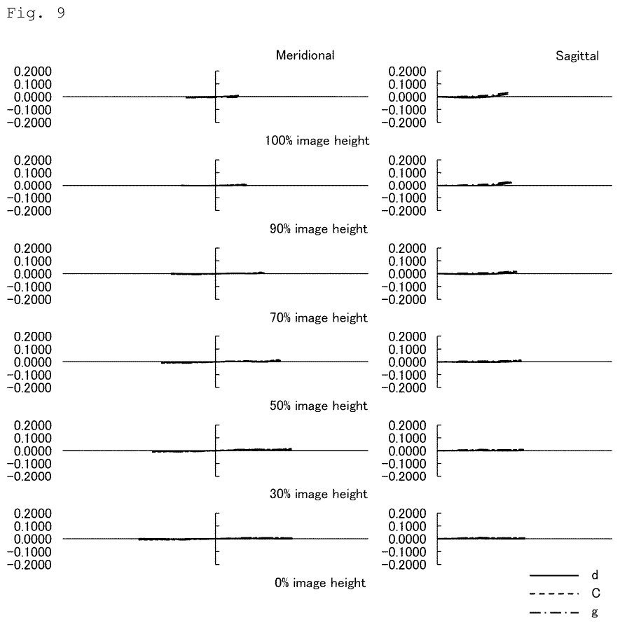

FIG. 10 is a lateral aberration diagram at a focusing distance of 832 mm in the optical system in Example 2;

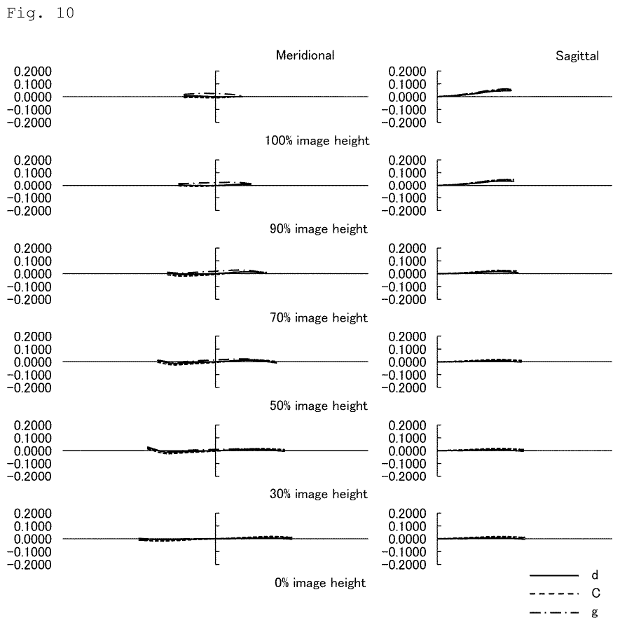

FIG. 11 is a lens cross-sectional view at infinity in an optical system in Example 3;

FIG. 12 is a longitudinal aberration diagram at infinity in the optical system in Example 3;

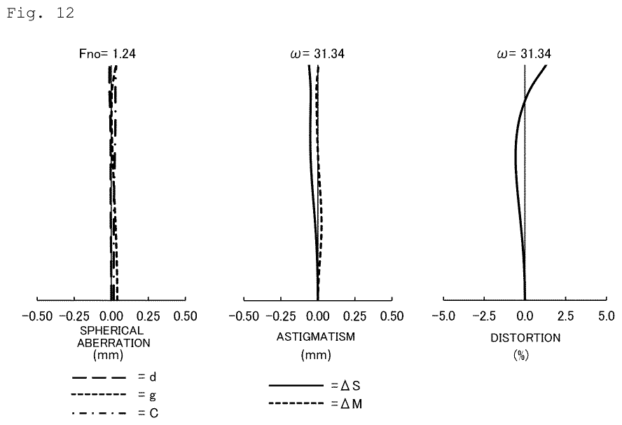

FIG. 13 is a longitudinal aberration diagram at a focusing distance of 250 mm in the optical system in Example 3;

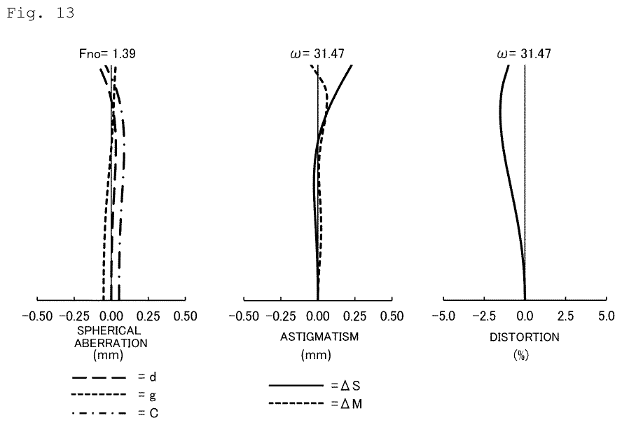

FIG. 14 is a lateral aberration diagram at infinity in the optical system in Example 3;

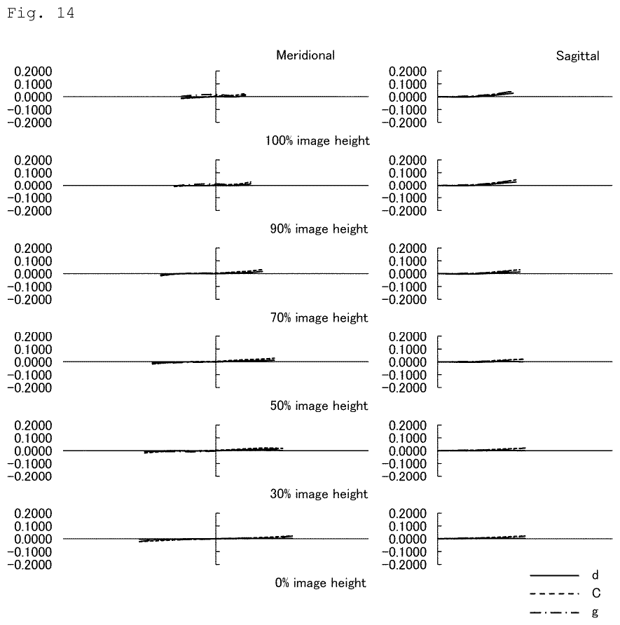

FIG. 15 is a lateral aberration diagram at a focusing distance of 250 mm in the optical system in Example 3;

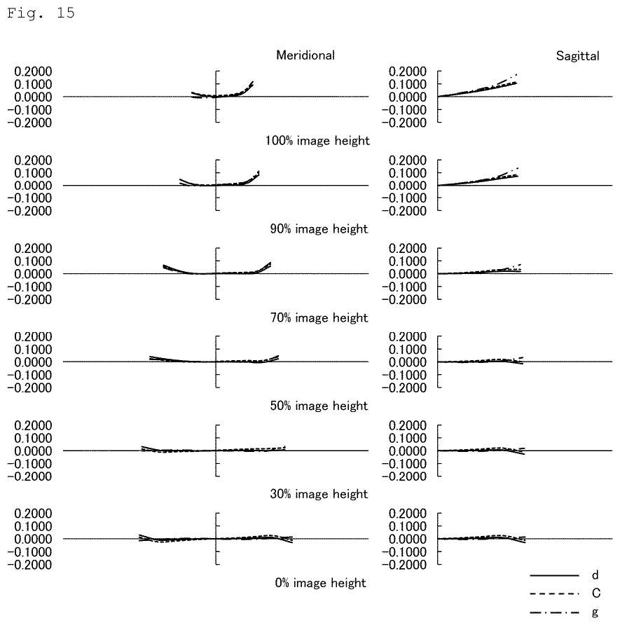

FIG. 16 is a lens cross-sectional view at infinity in an optical system in Example 4;

FIG. 17 is a longitudinal aberration diagram at infinity in the optical system in Example 4;

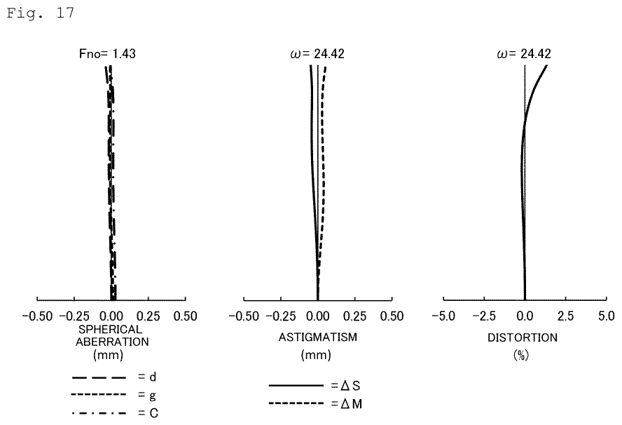

FIG. 18 is a longitudinal aberration diagram at a focusing distance of 394 mm in the optical system in Example 4;

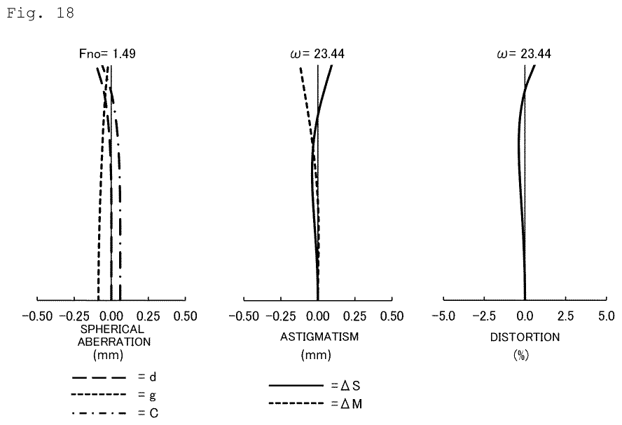

FIG. 19 is a lateral aberration diagram at infinity in the optical system in Example 4;

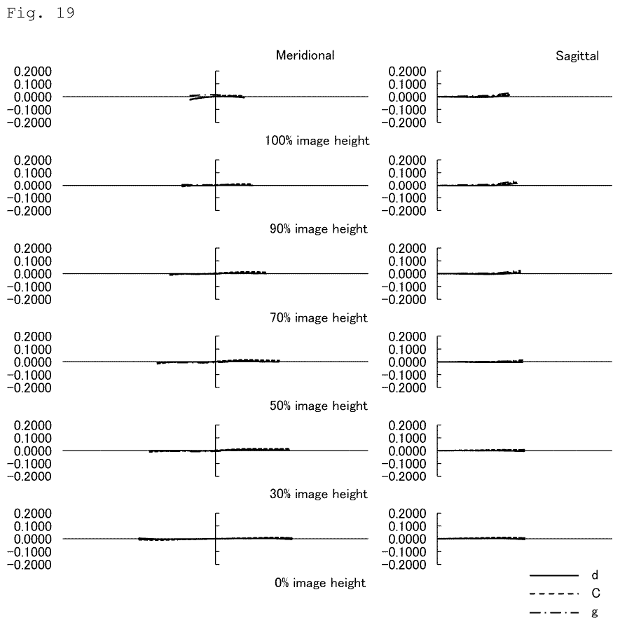

FIG. 20 is a lateral aberration diagram at a focusing distance of 394 mm in the optical system in Example 4;

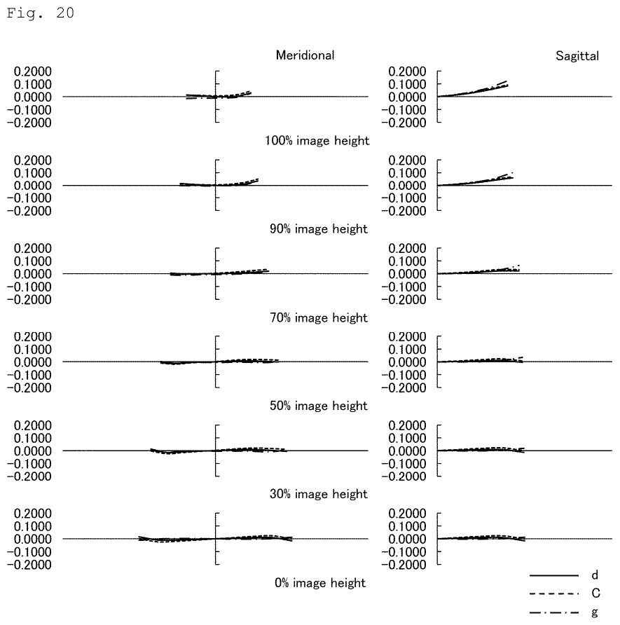

FIG. 21 is a lens cross-sectional view at infinity in an optical system in Example 5;

FIG. 22 is a longitudinal aberration diagram at infinity in the optical system in Example 5;

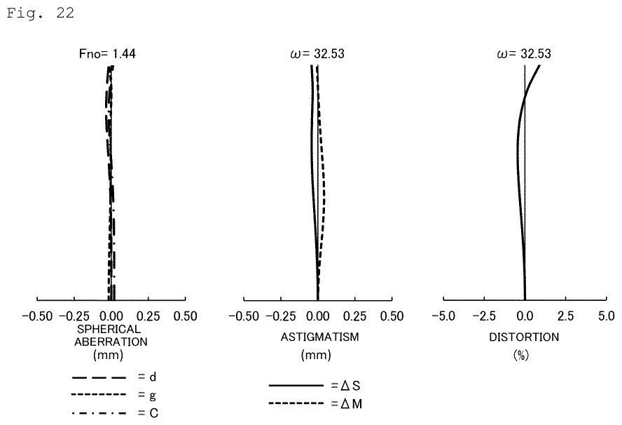

FIG. 23 is a longitudinal aberration diagram at a focusing distance of 250 mm in the optical system in Example 5;

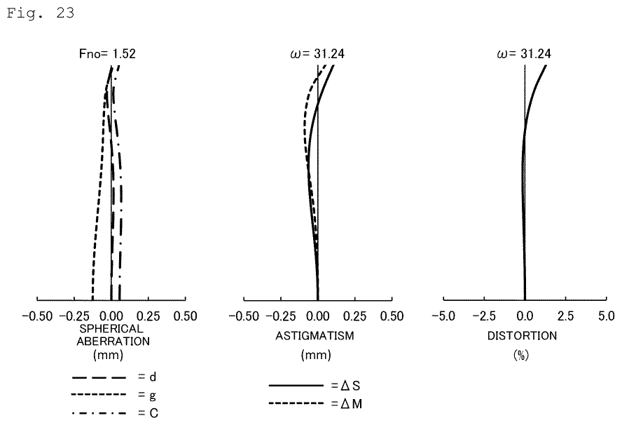

FIG. 24 is a lateral aberration diagram at infinity in the optical system in Example 5;

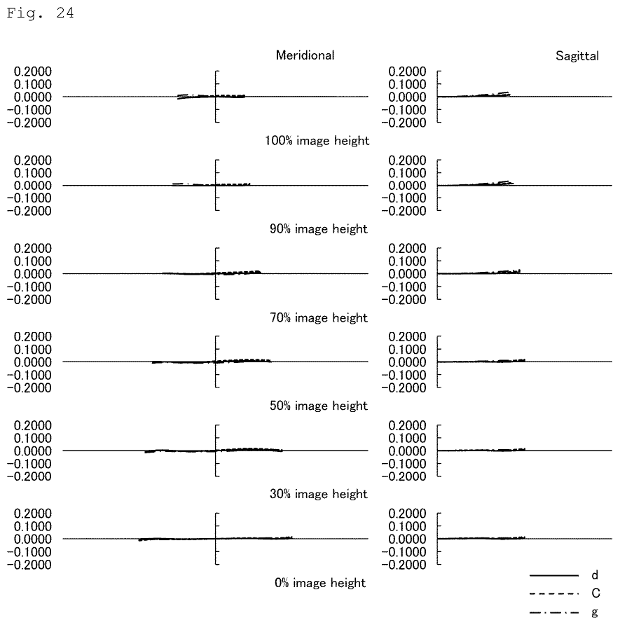

FIG. 25 is a lateral aberration diagram at a focusing distance of 250 mm in the optical system in Example 5;

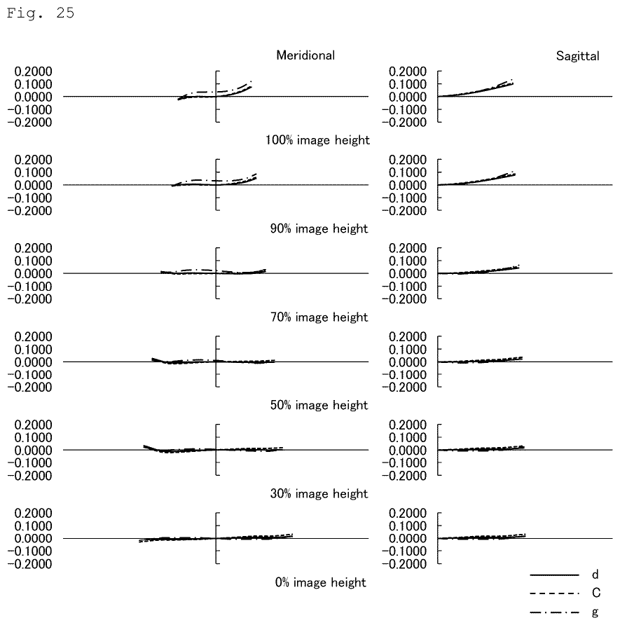

FIG. 26 is a lens cross-sectional view at infinity in an optical system in Example 6;

FIG. 27 is a longitudinal aberration diagram at infinity in the optical system in Example 6;

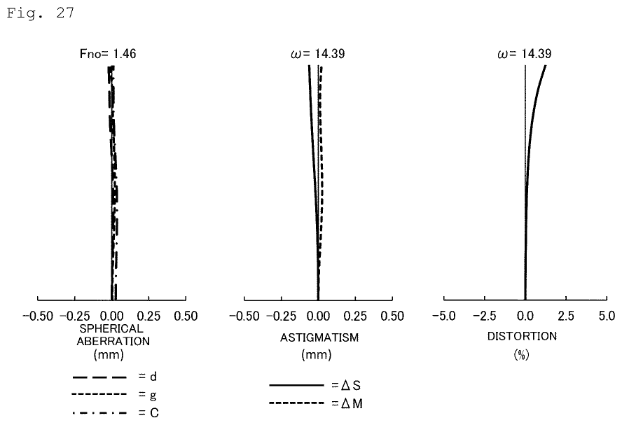

FIG. 28 is a longitudinal aberration diagram at a focusing distance of 815 mm in the optical system in Example 6;

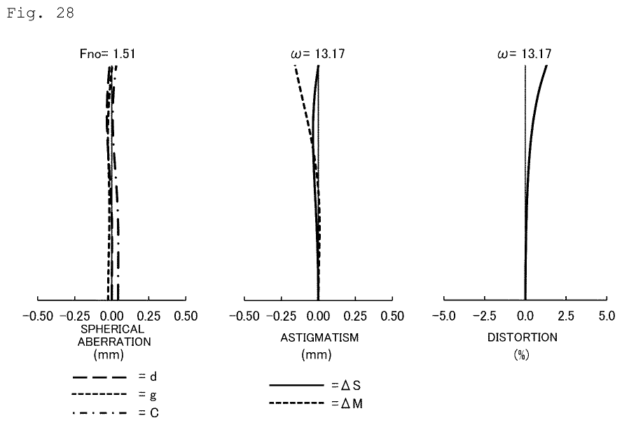

FIG. 29 is a lateral aberration diagram at infinity in the optical system in Example 6; and

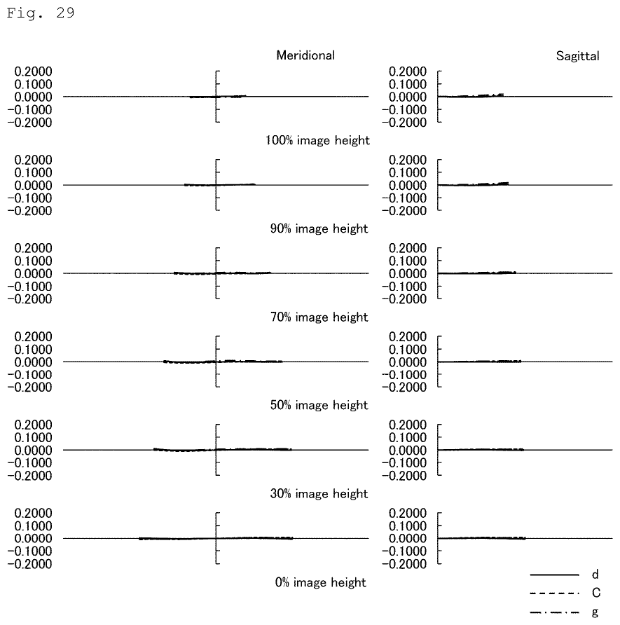

FIG. 30 is a lateral aberration diagram at a focusing distance of 815 mm in the optical system in Example 6.

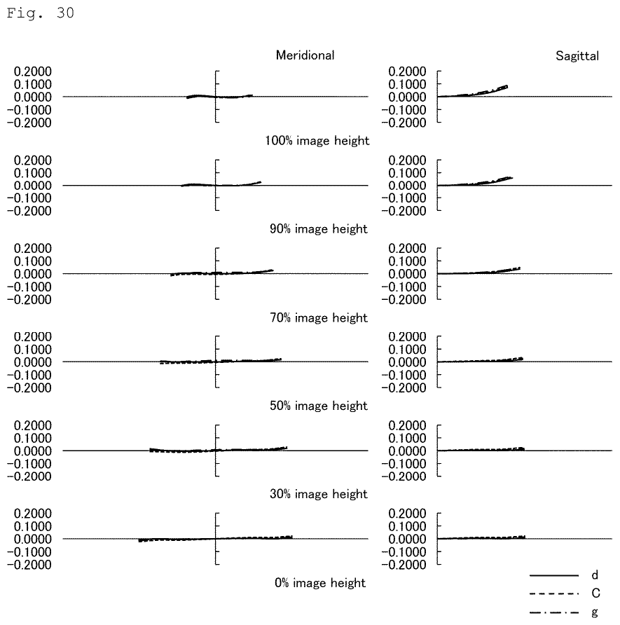

### DESCRIPTION OF EMBODIMENTS

Hereinbelow, in an optical system of the present invention, refractive indices of a material with respect to a g-line (at a wavelength of 435.8 nm), an F-line (486.1 nm), a d-line (587.6 nm), and a C-line (656.3 nm) are respectively denoted by Ng, NF, Nd, and NC. Meanwhile, as a refractive index not particularly specified, the refractive index with respect to the d-line is shown.

In addition, it is assumed that an abbe number vd, a partial dispersion ratio PgF, and an anomalous partial dispersion ΔPgF are derived from the following expressions:

$$vd = ( Nd - 1 ) / ( NF - NC )$$

$$PgF = ( Ng - NF ) / ( NF - NC )$$

$$Δ PgF = PgF - 0.64833 + 0.0018 \times vd$$

A detailed description will be given of examples of the optical system of the present invention. Note that the following description of the examples is that of an example of the optical system of the present invention, and the present invention is not intended to be limited to the present examples within a scope not departing from the gist thereof.

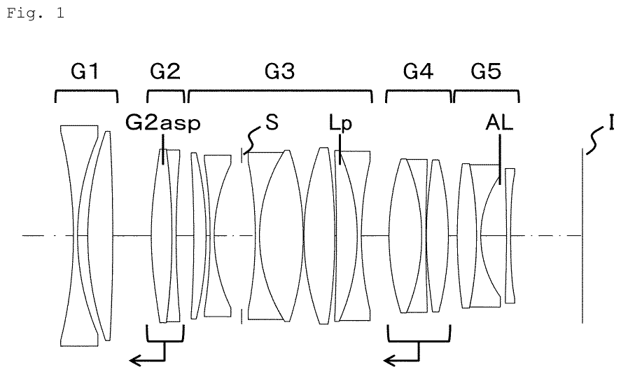

As can be seen from lens configuration diagrams illustrated in FIGS. 1, 6, 11, 16, 21, and 26, the optical system of the present invention is configured to include, in order from an object side, a first lens group G1, a second lens group G2 with a positive refractive power, a third lens group G3, a fourth lens group G4 with a positive refractive power, and a fifth lens group G5 with a negative refractive power, when focusing from infinity to a close distance, the second lens group G2 and the fourth lens group G4 move to the object side with different paths along an optical axis, the second lens group G2 includes an aspherical lens G2asp having such a shape as to reduce a convex power from a center of the optical axis to a periphery, and the fourth lens group G4 includes one or more lenses each having at least a positive refractive power and one or more lenses each having at least a negative refractive power.

By moving the two lens groups with the different paths during the focusing, it becomes easier to correct various aberrations from infinity to a close distance, particularly spherical aberration, astigmatism, and comatic aberration. In addition, in the second lens group G2 extending to the object side from infinity to a close distance, by disposing the aspherical lens G2asp having such a shape as to reduce the convex power from the center of the optical axis to a periphery, it is possible to give an effect of cancelling an effect of narrowing an angle of view on a close distance side relative to infinity, and consequently it becomes possible to suppress occurrence of so-called focus breathing. Moreover, since the shape has an effect of causing negative distortion, even when a telescopic ratio of the optical system is increased for a size reduction thereof, it is possible to suppress occurrence of positive distortion. Furthermore, by arranging the one or more lenses each having at least the positive refractive power and the one or more lenses each having at least the negative refractive power in the fourth lens group G4, it becomes possible to suppress chromatic aberration fluctuations resulting from the focusing, which contributes to a higher image quality. In addition, by providing the fifth lens group G5 with the negative refractive power, it is possible to bring an exit pupil closer to an image side, and therefore it is possible to suppress vignetting of a peripheral field angle due to camera mount diameter restrictions and suppress a reduction in light intensity which may affect an image quality.

In addition, in the optical system of the present invention, the fifth lens group G5 satisfies the following conditional expression (1), and the third lens group G3 includes a lens Lp with a positive refractive power simultaneously satisfying the following conditional expressions (2) and (3):

$$1.1 < β G 5 < 1.6 \qquad ( 1 )$$

$$0.021 < Lp\_ΔPgF < 0.055 \qquad ( 2 )$$

$$1 / ( Lp\_f \times Lp\_vd ) < 0.0020 \qquad ( 3 )$$

where
βG5: a lateral magnification of the fifth lens group G5 when focusing on infinity,
Lp_ΔPgF: an anomalous partial dispersion ΔPgF of the lens Lp with the positive refractive power configured to be included in the third lens group G3,
Lp_vd: an abbe number vd of the lens Lp with the positive refractive power configured to be included in the third lens group G3, and
Lp_f: a focal length (mm) of the lens Lp with the positive refractive power configured to be included in the third lens group G3 when not joined.

The conditional expression (1) defines the lateral magnification of the fifth lens group G5. The fifth lens group G5 having the negative refractive power has an effect of enlarging aberration having occurred in the optical system in front thereof. In particular, on-axis chromatic aberration is multiplied by a square of the lateral magnification, and consequently an effect thereof is unignorable in such a lens with a large aspect ratio as that used in the present invention. Meanwhile, when the lateral magnification of the fifth lens group G5 can be increased, the increased lateral magnification thereof is advantageous in shortening the entire length of the optical system, and therefore it is necessary to keep the lateral magnification within an appropriate range. When the lateral magnification increases to exceed an upper limit of the conditional expression (1), the entire length of the optical system can be reduced, but it becomes difficult to sufficiently correct the on axis chromatic aberration. When the lateral magnification decreases to exceed a lower limit of the conditional expression (1), the on-axis chromatic aberration can sufficiently be corrected, but the optical system is undesirably enlarged.

To more reliably achieve the effect with respect to the conditional expression (1) mentioned above, it is preferable to set a lower limit value to 1.15 and set an upper limit value to 1.55. By further setting the lower limit value and the upper limit value of the conditional expression (1) to 1.20 and 1.50, the effect of the present invention can further be achieved more favorably.

The conditional expression (2) and the conditional expression (3) define relationships between the anomalous partial dispersion ΔPgF of a lens Lp with the positive refractive power to be used in the third lens group G3 and the abbe number vd and focal length f thereof. In a case of such an optical system with a large aspect ratio as that of the present invention, it is necessary to strongly correct the on axis chromatic aberration that may affect coloring of the entire screen. In the optical system of the present invention, since the fifth lens group G5 is an enlarged system, it is important to perform sufficient aberration correction on a front side of the fifth lens group G5. In particular, the third lens group G3 is disposed in the vicinity of a center of the optical system and is at an advantageous position to strongly correct the on-axis chromatic aberration, while minimizing an effect given to magnification chromatic aberration, and therefore lenses to be used in the third lens group G3 need appropriately be chosen. As a means effective for the correction of the on axis chromatic aberration, it is common practice to choose, for a positive lens, a material having a positive anomalous partial dispersion and having an extremely low dispersion (such as e.g., FCD1 manufactured by HOYA corporation). However, such a material has a low refractive index, and is therefore disadvantageous to a size reduction of a product. Meanwhile, a glass material such as the lens Lp with the positive refractive power used in the present invention features an extremely high refractive index and accordingly, by using the glass material so as to simultaneously satisfy the conditional expression (2) and the conditional expression (3), it is possible to reduce a product size, while correcting the chromatic aberration. Note that the conditional expression (2) defines a range required for second order color elimination conditions and the conditional expression (3) defines a range required for first order color elimination conditions and, when the conditional expression ranges are exceeded, it becomes difficult to achieve a sufficient color elimination effect.

When the anomalous partial dispersion of the lens Lp increases to exceed an upper limit of the conditional expression (2), a second-order color elimination effect unfavorably becomes excessive. When the anomalous partial dispersion of the lens Lp decreases to exceed a lower limit of the conditional expression (2), the second-order color elimination effect becomes insufficient, and it is difficult to sufficiently correct the chromatic aberration. When the abbe number or focal length of the lens Lp decreases to exceed an upper limit of the conditional expression (3), a first order color elimination effect cannot sufficiently be achieved, and it is difficult to correct the chromatic aberration.

To more reliably ensure the effect with respect to the conditional expression (2) described above, it is preferable to set a lower limit value to 0.023 and set an upper limit value to 0.053. By further setting the lower limit value and the upper limit value of the conditional expression (2) to 0.026 and 0.050, the effect of the present invention can further be achieved more favorably. Likewise, to more reliably ensure the effect with respect to the conditional expression (3) described above, it is preferable to set an upper limit value to 0.0017. By further setting the upper limit value of the conditional expression (3) to 0.0013, the effect of the present invention can further be achieved more favorably.

Moreover, in the optical system of the present invention, the following conditional expressions are satisfied:

$$1. < f 2 / f 4 < 6. \qquad ( 4 )$$

$$( f 4 / vd\_G4ave ) / f < 0.050 \qquad ( 5 )$$

where
f: a focal length (mm) when focusing on infinity,
f2: focal length (mm) of the second lens group G2 when focusing on infinity,
f4: a focal length (mm) of the fourth lens group G4 when focusing on infinity, and
vd_G4ave: an average value of abbe numbers vd of positive lenses included in the fourth lens group G4.

The conditional expression (4) defines a ratio between the respective focal lengths of the second lens group G2 and the fourth lens group G4, which serve as the focus groups. The optical system of the present invention adopts floating during focusing, and has a configuration in which spherical aberration, field curvature, and comatic aberration caused in the individual focus groups cancel out each other. In addition, by keeping the focal length ratio within an appropriate range, it is possible to distribute even a focusing action, and therefore it is possible to reduce a total focus movement amount of the second lens group G2 and the fourth lens group G4.

When the focal length of the fourth lens group G4 relatively decreases to exceed an upper limit of the conditional expression (4), it becomes possible to reduce the focus movement amount, but the various aberrations cannot sufficiently cancel out each other, and it becomes difficult to sufficiently suppress aberration fluctuations during focusing. Meanwhile, when the focal length of the fourth lens group G4 relatively increases to exceed a lower limit of the conditional expression (4), the various aberrations can cancel out each other, but the focus movement amount increases to unfavorably increase a total optical length.

To more reliably ensure the effect with respect to the conditional expression (4) described above, it is preferable to set a lower limit value to 1.2 and set an upper limit value to 5.8. By further setting the lower limit value and the upper limit value of the conditional expression (4) to 1.4 and 5.6, the effect of the present invention can further be achieved more favorably.

The conditional expression (5) determines a relationship between a ratio between the focal length of the fourth lens group G4 serving as the focus group and an average of the abbe numbers of the positive lenses thereof and the focal length of the entire system. Since an amount of the caused chromatic aberration increases as the focal length of the lens increases or the abbe number decreases, the conditional expression (5) defines the amount of the chromatic aberration caused in the fourth lens group G4. The fourth lens group G4 has the positive refractive power, and accordingly the abbe numbers of the positive lenses included in the group are particularly important. In addition, to perform satisfactory chromatic aberration correction from infinity to a close distance, the chromatic aberration caused in the fourth lens group G4 serving as the focus group is preferably smaller and, when the focal length of the fourth lens group G4 relatively increases to exceed an upper limit of the conditional expression (5) or when the average value of the abbe numbers decreases, it becomes difficult to sufficiently suppress the chromatic aberration fluctuations during focusing.

To more reliably ensure the effect with respect to the conditional expression (5) described above, it is preferable to set an upper limit value to 0.045. By further setting the upper limit value of the conditional expression (5) to 0.040, the effect of the present invention can further be achieved more favorably.

Furthermore, in the optical system of the present invention, the fifth lens group G5 includes an air lens AL configured including two adjacent lenses and satisfies the following conditional expression:

$$- 1. < ( R 2 air + R 1 air ) / ( R 2 air - R 1 air ) < 1. \qquad ( 6 )$$

where
R1air: an object-side curvature radius (mm) of the air lens AL configured to be included in the fifth lens group G5, and
R2air: an image-side curvature radius (mm) of the air lens AL configured to be included in the fifth lens group G5.

The conditional expression (6) defines a shape of the air lens AL produced in the fifth lens group G5, and is a so-called shape factor. The conditional expression (6) specifies a range in which the air lens AL has a biconvex shape and, by forming the air lens AL in the fifth lens group G5 close to an image surface and having an on-axis light flux diameter which tends to decrease, it is possible to correct a Petzval sum with negative refractive effects of both surfaces and correct the field curvature. In addition, the curvature radius represented by R2air preferably has a negative value which allows a concave surface to face the object side. When the curvature radius represented by R2air becomes positive or nearly positive, an angle of incidence of an off-axis ray to the surface increases to cause large comatic aberration and astigmatism, and consequently it is difficult to provide higher performance. Meanwhile, the curvature radius represented by R1air preferably has a positive value which allows a convex surface to face the object side. When the curvature radius represented by R1air becomes negative or nearly negatively, it is difficult to sufficiently narrow down the light flux on the object side of the air lens AL, and consequently the four groups serving as the focus groups are enlarged and unfavorably cannot perform a high-speed AF operation. Therefore, it is necessary that R1air has a positive value, while R2air has a negative value.

In addition, when the curvature radius represented by R1air decreases to exceed an upper limit of the conditional expression (6), the negative refractive power on the object side of the lens AL becomes excessively high, and large positive distortion occurs unfavorably. When the curvature radius represented by R2air increases to exceed a lower limit of the conditional expression (6), the angle of incidence of the off-axis ray to the surface excessively decreases, and the comatic aberration cannot sufficiently be corrected unfavorably.

To more reliably ensure the effect with respect to the conditional expression (6) described above, it is preferable to set a lower limit value to-0.50 and set an upper limit value to 0.95. By further setting the lower limit value and the upper limit value of the conditional expression (6) to 0.00 and 0.90, the effect of the present invention can further be achieved more favorably.

Furthermore, in the optical system of the present invention, the following conditional expression is satisfied:

$$0.0 \; 05 < \vert ( G 2 aspHnr - G 2 aspHinf ) / f\_G 2 \vert < 0. 050 \qquad ( 7 )$$

where
G2aspHinf: a ray height (mm) of an off-axis principal ray at an object side surface of the aspherical lens G2asp when focusing on infinity,
G2aspHnr: a ray height (mm) of the off axis principal ray at the object side surface of the aspherical lens G2asp when focusing on a closest distance, wherein the off-axis principal ray is a ray passing through a point of intersection of an aperture diaphragm with the optical axis at a largest angle of view, and
f2: a focal length (mm) of the second lens group G2 when focusing on infinity.

The conditional expression (7) defines a ratio between a focus variation amount at the ray height of the off-axis principal ray passing through the object side surface of the aspherical lens G2asp in the second lens group G2 and a focal length of the second lens group G2. To suppress the focus breathing, using the aspherical lens G2asp in the second lens group G2 serves as an effective means but, to allow the effect thereof to be sufficiently achieved, it is important to greatly change the height of the off-axis principal ray passing through the aspherical lens G2asp during focusing. To greatly move a ray passage position, it may be appropriate to increase the focal length of the second lens group G2 to ensure the focus movement amount but, since the focusing action simultaneously deteriorates to incur enlargement in a thrust direction, it is necessary to keep the focal length of the second lens group G2 within an appropriate range.

When an absolute value of the focal length of the second lens group G2 decreases to exceed an upper limit of the conditional expression (7), the aberration fluctuations during focusing increase, and it becomes difficult to suppress the focus breathing, while satisfactorily correcting the various aberrations. When the absolute value of the focal length of the second lens group G2 increases to exceed a lower limit of the conditional expression (7), it becomes possible to suppress the aberration fluctuations during focusing and the focus breathing, but the optical system is unfavorably enlarged in the thrust direction.

To more reliably ensure the effect with respect to the conditional expression (7) described above, it is preferable to set a lower limit value to 0.007 and set an upper limit value to 0.045. By further setting the lower limit value and the upper limit value of the conditional expression (7) to 0.009 and 0.040, the effect of the present invention can further be achieved more favorably.

Furthermore, in the optical system of the present invention, the third lens group G3 has an aperture diaphragm S.

Since the third lens group G3 is disposed in the vicinity of the center of the optical system of the present invention, by providing the aperture diaphragm S therein, it is possible to bring the center of the optical system closer to a pupil center. As a result, symmetrical power distribution is easily provided in the optical system, and accordingly correction of the various aberrations represented by the distortion is easily performed, and therefore it is possible to improve optical performance. In addition, since it is possible to provide a configuration in which the focus groups are divided into front and rear groups with the aperture diaphragm S being interposed therebetween, it is possible to independently dispose a unit including an actuator which drives a focus and the aperture diaphragm S and suppress the enlargement in a direction perpendicular to an optical axis. Moreover, since it becomes easier to provide upper and lower marginal rays with distances symmetrical with respect to the principal ray, an amount of marginal light when significantly reduced is likely to recover, and it is possible to prevent an image from looking unnatural even when electronic correction is performed.

Furthermore, in the optical system of the present invention, the fourth lens group G4 includes an aspherical lens with a positive refractive power.

The fourth lens group G4 is the image side focus group, and has not only the focusing action, but also a function of cancelling aberration caused in the second lens group G2 serving as the object side focus group. In particular, it is necessary to strongly correct the spherical aberration and comatic aberration caused in the second lens group G2 but, when a plurality of lenses are used to correct these aberrations, the fourth lens group G4 becomes larger and heavier, which not only incurs enlargement of the actuator, but also unfavorably hinders a high speed AF operation. However, since each of the spherical aberration and the comatic aberration is monochromatic aberration, by disposing the aspherical lens in the fourth lens group G4, it is possible to correct these aberrations. In addition, since the fourth lens group G4 has the positive refractive power, the aspherical lens used for the correction preferably has a positive refractive power. This allows a configuration in which the number of constituent lenses is reduced, while satisfactorily correcting the various aberrations, and therefore it is possible to reduce a weight of a focus movable portion and simultaneously achieve high speed AF and higher performance.

Furthermore, in the optical system of the present invention, the fifth lens group G5 includes an aspherical lens with a negative refractive power on a side thereof closest to an image.

The fifth lens group G5 is disposed at a position where the off-axis ray is higher in level than the on axis ray and, in a group through which the rays thus pass, it is possible to particularly strongly correct the off axis aberration. Accordingly, by disposing an aspherical lens such that the negative refractive power increases from the center of the optical center toward the periphery in the fifth lens group G5, it becomes possible to effectively correct the field curvature and distortion without increasing the number of lenses and simultaneously achieve a size reduction and higher performance. Note that, since the aspherical lens disposed at a place where a difference between the on axis ray height and the off-axis ray height is larger is more effectively operated, the aspherical lens is preferably disposed on the side closest to the image.

Next, a description will be given of a lens configuration in examples related to the optical system of the present invention. Note that, in the following description, the lens configuration will be described in order from the object side to the image side.

### Example 1

FIG. 1 is a lens configuration diagram of an optical system in Example 1 of the present invention. The optical system is configured to include the first lens group G1 with a positive refractive power, the second lens group G2 with a positive refractive power, the third lens group G3 with a positive refractive power, the fourth lens group G4 with a positive refractive power, and the fifth lens group G5 with a negative refractive power, and focusing from infinity to a close distance is performed by the second lens group G2 and the fourth lens group G4 by moving to the object side with different paths.

The first lens group G1 is configured to include a negative lens with a biconcave shape and a positive lens with a biconvex shape.

The second lens group G2 is configured to include a cemented lens including the positive lens G2asp with a biconvex shape having an aspherical surface as the object side surface and a negative lens with a biconcave shape.

The third lens group G3 is configured to include a positive meniscus lens with a concave surface facing the object side, a negative lens with a biconcave shape, the aperture diaphragm S, a cemented lens including a negative lens with a biconcave shape and a positive lens with a biconvex shape, a positive lens with a biconvex shape having aspherical surfaces on both sides, and a cemented lens including a positive meniscus lens Lp with a concave surface facing the object side and a negative lens with a biconcave shape.

The fourth lens group G4 is configured to include a cemented lens including a positive lens with a biconvex shape and a negative lens with a biconcave shape and a positive lens with a biconvex shape having an aspherical surface as the object side surface.

The fifth lens group G5 is configured to include a cemented lens including a positive lens with a biconvex shape and a negative lens with a biconcave shape and a negative lens with a biconcave shape having aspherical surfaces on both sides, and the air lens AL is formed between the cemented lens and the negative lens.

### Example 2

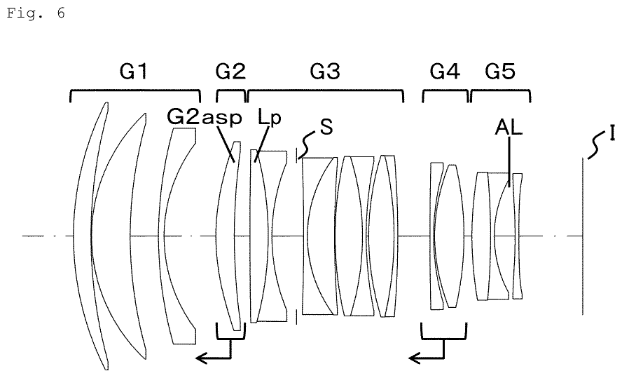

FIG. 6 is a lens configuration diagram of an optical system in Example 2 of the present invention. The optical system is configured to include the first lens group G1 with a positive refractive power, the second lens group G2 with a positive refractive power, the third lens group G3 with a positive refractive power, the fourth lens group G4 with a positive refractive power, and the fifth lens group G5 with a negative refractive power, and focusing from infinity to a close distance is performed by the second lens group G2 and the fourth lens group G4 by moving to the object side with different paths.

The first lens group G1 is configured to include a positive meniscus lens with a convex surface facing the object side, a positive meniscus lens with a concave surface facing the object side, and a negative meniscus lens with a convex surface facing the object side.

The second lens group G2 is configured to include the positive meniscus lens G2asp with a convex surface facing the object side having an aspherical surface as the object side surface.

The third lens group G3 is configured to include a cemented lens including the positive lens Lp with a biconvex shape and a negative lens with a biconcave shape, the aperture diaphragm S, a cemented lens including a negative lens with a biconcave shape and a positive meniscus lens with a convex surface facing the object side, a cemented lens including a positive lens with a biconvex shape and a negative lens with a biconcave shape, and a cemented lens including a positive lens with a biconvex shape and a negative meniscus lens with a concave surface facing the object side.

The fourth lens group G4 is configured to include a negative meniscus lens with a convex surface facing the object side and a positive lens with a biconvex shape having an aspherical surface as the object side surface.

The fifth lens group G5 is configured to include a cemented lens including a positive lens with a biconvex shape and a negative lens with a biconcave shape and a negative lens with a biconcave shape having aspherical surfaces on both sides, and the air lens AL is formed between the cemented lens and the negative lens.

### Example 3

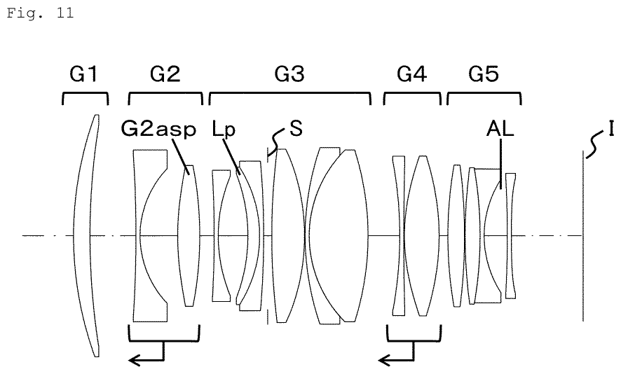

FIG. 11 is a lens configuration diagram of an optical system in Example 3 of the present invention. The optical system is configured to include the first lens group G1 with the positive refractive power, the second lens group G2 with the positive refractive power, the third lens group G3 with the positive refractive power, the fourth lens group G4 with the positive refractive power, and the fifth lens group G5 with the negative refractive power, and focusing from infinity to a close distance is performed by the second lens group G2 and the fourth lens group G4 by moving to the object side with different paths.

The first lens group G1 is configured to include a positive meniscus lens with a concave surface facing the object side.

The second lens group G2 is configured to include a negative lens with a biconcave shape and the positive lens G2asp with a biconvex shape having aspherical surfaces on both sides.

The third lens group G3 is configured to include a negative lens with a biconcave shape, a cemented lens including the positive meniscus lens Lp with a concave surface facing the object side and a negative meniscus lens with a concave surface facing the object side, the aperture diaphragm S, a positive lens with a biconvex shape having aspherical surfaces on both sides, and a cemented lens including a negative meniscus lens with a convex surface facing the object side and a positive lens with a biconvex shape.

The fourth lens group G4 is configured to include a negative lens with a biconcave shape and a positive lens with a biconvex shape having aspherical surfaces on both sides.

The fifth lens group G5 is configured to include a positive lens with a biconvex shape, a cemented lens including a positive lens with a biconvex shape and a negative lens with a biconcave shape, and a negative lens with a biconcave shape having aspherical surfaces on both sides, and the air lens AL is formed between the cemented lens and the negative lens.

### Example 4

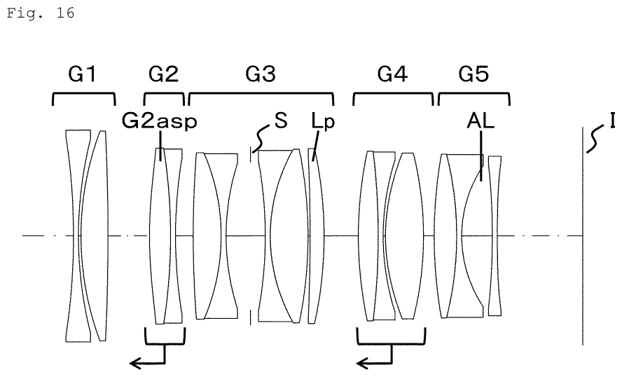

FIG. 16 is a lens configuration diagram of an optical system in Example 4 of the present invention. The optical system is configured to include the first lens group G1 with a positive refractive power, the second lens group G2 with a positive refractive power, the third lens group G3 with a positive refractive power, the fourth lens group G4 with a positive refractive power, and the fifth lens group G5 with a negative refractive power, and focusing from infinity to a close distance is performed by the second lens group G2 and the fourth lens group G4 by moving to the object side with different paths.

The first lens group G1 includes a negative lens with a biconcave shape and a positive lens with a biconvex shape.

The second lens group G2 is configured to include a cemented lens including the positive lens G2asp with a biconvex shape having an aspherical surface as the object side surface and a negative lens with a biconcave shape.

The third lens group G3 is configured to include a cemented lens including a positive lens with a biconvex shape and a negative lens with a biconcave shape, the aperture diaphragm S, a cemented lens including a negative lens with a biconcave shape and a positive lens with a biconvex shape, and the positive meniscus lens Lp with a concave surface facing the object side.

The fourth lens group G4 is configured to include a cemented lens including a positive lens with a biconvex shape and a negative lens with a biconcave shape and a positive lens with a biconvex shape having an aspherical surface as the object side surface.

The fifth lens group G5 is configured to include a cemented lens including a positive lens with a biconvex shape and a negative lens with a biconcave shape and a negative lens with a biconcave shape having aspherical surfaces on both sides, and the air lens AL is formed between the cemented lens and the negative lens.

### Example 5

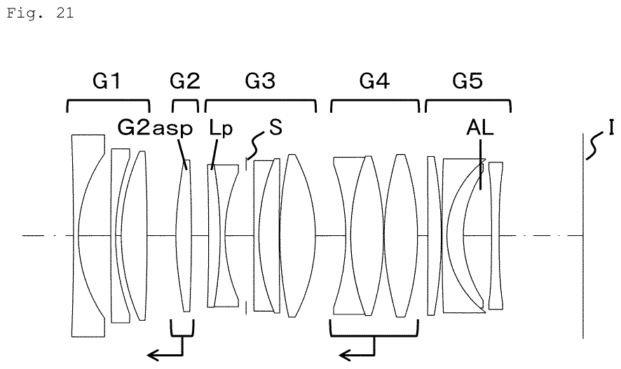

FIG. 21 is a lens configuration diagram of an optical system in Example 5 of the present invention. The optical system is configured to include the first lens group G1 with a negative refractive power, the second lens group G2 with a positive refractive power, the third lens group G3 with a positive refractive power, the fourth lens group G4 with a positive refractive power, and the fifth lens group G5 with a negative refractive power, and focusing from infinity to a close distance is performed by the second lens group G2 and the fourth lens group G4 by moving to the object side with different paths.

The first lens group G1 is configured to include a negative lens with a biconcave shape, a negative meniscus lens with a convex surface facing the object side, and a positive lens with a biconvex shape.

The second lens group G2 is configured to include the positive lens G2asp with a biconvex shape having aspherical surfaces on both sides.

The third lens group G3 is configured to include a cemented lens including the positive meniscus lens Lp with a concave surface facing the object side and a negative lens with a biconcave shape, the aperture diaphragm S, a cemented lens including a negative lens with a biconcave shape and a positive meniscus lens with a convex surface facing the object side, and a positive lens with a biconvex shape.

The fourth lens group G4 is configured to include a cemented lens including a negative lens with a biconcave shape and a positive lens with a biconvex shape and a positive lens with a biconvex shape having aspherical surfaces on both sides.

The fifth lens group G5 is configured to include a positive meniscus lens with a concave surface facing the object side, a cemented lens including a negative meniscus lens with a convex surface facing the object side and a positive meniscus lens with a convex surface facing the object side, and a negative lens with a biconcave shape having aspherical surfaces on both sides, and the air lens AL is formed between the cemented lens and the negative lens.

### Example 6

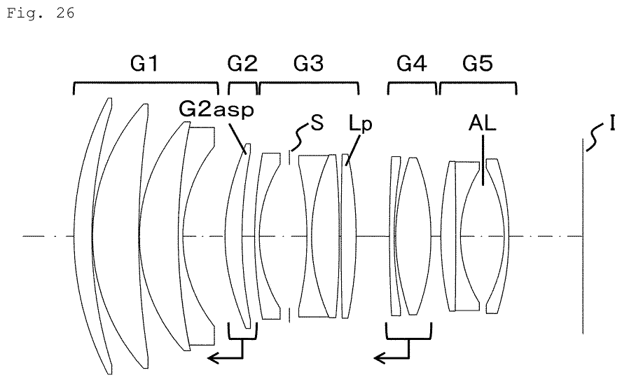

FIG. 26 is a lens configuration diagram of an optical system in Example 6 of the present invention. The optical system is configured to include the first lens group G1 with a positive refractive power, the second lens group G2 with a positive refractive power, the third lens group G3 with a negative refractive power, the fourth lens group G4 with a positive refractive power, and the fifth lens group G5 with a negative refractive power, and focusing from infinity to a close distance is performed by the second lens group G2 and the fourth lens group G4 by moving to the object side with different paths.

The first lens group G1 is configured to include a positive meniscus lens with a convex surface facing the object side, a positive meniscus lens with a convex surface facing the object side, and a cemented lens including a positive meniscus lens with a convex surface facing the object side and a negative meniscus lens with a convex surface facing the object side.

The second lens group G2 is configured to include the positive meniscus lens G2asp with a convex surface facing the object side having an aspherical surface as the object side surface.

The third lens group G3 is configured to include a negative meniscus lens with a concave surface facing the object side, the aperture diaphragm S, a cemented lens including a negative lens with a biconcave shape and a positive lens with a biconvex shape, and the positive lens Lp with a biconvex shape.

The fourth lens group G4 is configured to include a negative meniscus lens with a convex surface facing the object side and a positive lens with a biconvex shape having aspherical surfaces on both sides.

The fifth lens group G5 is configured to include a cemented lens including a positive lens with a biconvex shape and a negative lens with a biconcave shape and a negative meniscus lens with a concave surface facing the object side having an aspherical surface as the object side surface, and the air lens AL is formed between the cemented lens and the negative meniscus lens.

The following will show specific numerical data in each of the examples of the imaging optical system of the present invention described above.

In [Surface Data], a surface number indicates a number of a lens surface or an aperture diaphragm which is counted from the object side, r denotes a curvature radius of each surface, d denotes a distance between the individual surfaces, nd denotes a refractive index to the d-line (587.6 nm), vd denotes an abbe number to the d-line, and PgF denotes a partial dispersion ratio to the g-line (at a wavelength of 435.8 nm) and the F-line (486.1 nm).

“* (asterisk)” added to the surface number indicates that a shape of the lens surface is that of an aspherical surface, while BF represents back focus.

(Diaphragm) added to the surface number indicates that an aperture diaphragm is located at that position. For a curvature radius to a plane or an aperture diaphragm, o (infinity) is filled in.

In [Aspherical Surface Data], various coefficient values which provide the lens surfaces each having * added thereto in [Surface Data] with aspherical surface shapes are shown. The shape of each of aspherical surfaces is such that, when a displacement from the optical axis in a direction perpendicular to the optical axis is y, a displacement (sag amount) from a point of intersection of the aspherical surface with the optical axis in an optical axis direction is z, a curvature radius of a reference spherical surface is r, a conic coefficient is K, and respective aspherical coefficients for individual orders are A4, A6, A8, . . . , coordinates of the aspherical surface are given by the following expression:

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12} + A 14 {y}^{14}$$

[Various Data] shows values such as focal lengths in focused states at respective focusing distances.

[Variable Distance Data] shows variable distance and BF values in the focused states at the respective focusing distances.

[Lens Group Data] shows a number of the surface configured to be included in each of the lens groups and closest to the object side and a composite focal length of the entire group.

For all values of specifications described below, millimeter (mm) is used as the unit for the focal length f, the curvature radius r, the lens surface distance d, and other lengths each shown therein unless otherwise particularly specified. However, in an optical system, equivalent optical performances can be obtained even in proportional enlargement and proportional reduction, and therefore the unit is not limited thereto.

In addition, a list of corresponding values of the conditional expressions in these examples is shown.

In the aberration diagrams corresponding to the respective examples, “d,” “g,” and “C” respectively represent the d-line, the g-line, and the C-line, while “AS” and “AM” represent a sagittal image surface and a meridional image surface.

### Numerical Example 1

Unit: mm
[Surface Data]

| Surface Number | r | d | nd | vd | PgF |
|---|---|---|---|---|---|
| Object Surface | ∞ | (d0) | | | |
| 1 | −107.5100 | 1.0000 | 1.51742 | 52.15 | |
| 2 | 61.9300 | 2.4700 | | | |
| 3 | 78.3300 | 6.0500 | 2.00100 | 29.13 | |
| 4 | −489.3000 | (d4) | | | |
| 5* | 88.2600 | 5.0000 | 1.76450 | 49.09 | |
| 6 | −167.8500 | 1.0000 | 1.59270 | 35.45 | |
| 7 | 215.0500 | (d7) | | | |
| 8 | −287.4900 | 2.9700 | 2.00100 | 29.13 | |
| 9 | −87.3400 | 0.9700 | | | |
| 10 | −125.8800 | 1.0000 | 1.59270 | 35.45 | |
| 11 | 40.8900 | 6.6600 | | | |
| 12 (Diaphragm) | ∞ | 3.3000 | | | |
| 13 | −97.6000 | 1.0100 | 1.85451 | 25.15 | |
| 14 | 39.1700 | 10.5800 | 1.75500 | 52.32 | |
| 15 | −68.5200 | 0.2000 | | | |
| 16* | 61.7100 | 7.4700 | 1.76450 | 49.09 | |
| 17* | −151.3000 | 0.4000 | | | |
| 18 | −487.9700 | 5.0400 | 1.98612 | 16.48 | 0.6656 |
| 19 | −52.2000 | 1.0000 | 1.85451 | 25.15 | |
| 20 | 80.8100 | (d20) | | | |
| 21 | 63.1000 | 7.9400 | 1.75500 | 52.32 | |
| 22 | −49.9400 | 1.0000 | 1.85451 | 25.15 | |
| 23 | 463.3100 | 0.1500 | | | |
| 24* | 96.7600 | 5.3100 | 1.80610 | 40.73 | |
| 25 | −76.0700 | (d25) | | | |
| 26 | 128.5400 | 4.6900 | 2.00069 | 25.46 | |
| 27 | −91.4600 | 1.0000 | 1.61396 | 44.29 | |
| 28 | 25.9500 | 6.2600 | | | |
| 29* | −300.0000 | 1.0000 | 1.85135 | 40.10 | |
| 30* | 267.1100 | (BF) | | | |
| Image Surface | ∞ | | | | |

[Aspherical Surface Data]

| | 5th Surface | 16th Surface | 17th Surface | 24th Surface | 29th Surface | 30th Surface |
|---|---|---|---|---|---|---|
| K | 0.00000 | 0.00000 | 0.00000 | 0.00000 | 0.00000 | 0.00000 |
| A4 | −2.17740E−06 | −6.48260E−07 | −4.35970E−07 | −2.75230E−06 | 4.09140E−06 | 1.05910E−05 |
| A6 | −8.59080E−10 | 7.12940E−10 | 3.04410E−10 | −8.33840E−10 | −2.83210E−08 | −2.73950E−08 |
| A8 | −3.99910E−13 | −6.61370E−13 | −7.50130E−13 | 3.37100E−13 | 1.79340E−10 | 2.21150E−10 |
| A10 | 4.24190E−16 | 4.59670E−16 | 5.39280E−16 | 0.00000E+00 | −7.13360E−13 | −8.81720E−13 |
| A12 | 0.00000E+00 | 0.00000E+00 | 0.00000E+00 | 0.00000E+00 | 1.30860E−15 | 1.85370E−15 |
| A14 | 0.00000E+00 | 0.00000E+00 | 0.00000E+00 | 0.00000E+00 | −8.76200E−19 | −1.57580E−18 |

[Various Data]

| | INF | 395 mm |
|---|---|---|
| Focal Length | 48.27 | 44.69 |
| F-Number | 1.24 | 1.38 |
| Entire Angle of View 2ω | 47.90 | 45.39 |
| Image Height Y | 21.63 | 21.63 |
| Entire Lens Length | 123.38 | 123.38 |

[Variable Distance Data]

| | INF | 395 mm |
|---|---|---|
| d0 | ∞ | 271.3770 |
| d4 | 9.3500 | 2.7500 |
| d7 | 4.3100 | 10.9100 |
| d20 | 6.6900 | 2.5600 |
| d25 | 2.1500 | 6.2800 |
| BF | 17.4116 | 17.4116 |

[Lens Group Data]

| Group | Starting Surface | Focal Length |
|---|---|---|
| G1 | 1 | 462.79 |
| G2 | 5 | 143.09 |
| G3 | 8 | 103398.14 |
| G4 | 21 | 39.03 |
| G5 | 26 | −57.37 |

### Numerical Example 2

Unit: mm
[Surface Data]

| Surface Number | r | d | nd | vd | PgF |
|---|---|---|---|---|---|
| Object Surface | ∞ | (d0) | | | |
| 1 | 81.1400 | 4.7000 | 1.75500 | 52.32 | |
| 2 | 129.4400 | 0.1500 | | | |
| 3 | 46.0800 | 10.4000 | 1.55032 | 75.50 | |
| 4 | 115.6000 | 7.6000 | | | |
| 5 | 109.6500 | 1.5000 | 1.60342 | 38.01 | |
| 6 | 42.2600 | (d6) | | | |
| 7* | 61.1100 | 4.9500 | 1.76450 | 49.09 | |
| 8 | 169.6900 | (d8) | | | |
| 9 | 1369.2000 | 4.9200 | 1.94594 | 17.98 | 0.6546 |
| 10 | −90.0600 | 1.0000 | 1.77047 | 29.74 | |
| 11 | 52.9500 | 6.5900 | | | |
| 12 (Diaphragm) | ∞ | 1.9300 | | | |
| 13 | −597.3400 | 1.0000 | 1.77047 | 29.74 | |
| 14 | 35.9500 | 7.3100 | 1.59282 | 68.62 | |
| 15 | 261.6500 | 0.1500 | | | |
| 16 | 96.4000 | 7.3600 | 1.85033 | 42.70 | |
| 17 | −73.6500 | 1.0000 | 1.77047 | 29.74 | |
| 18 | 100.9000 | 0.6800 | | | |
| 19 | 74.8000 | 6.8000 | 2.00100 | 29.13 | |
| 20 | −98.0000 | 1.0000 | 1.77047 | 29.74 | |
| 21 | −263.8100 | (d21) | | | |
| 22 | 841.3100 | 1.0000 | 1.84666 | 23.78 | |
| 23 | 64.9200 | 0.2700 | | | |
| 24* | 48.1000 | 7.8800 | 1.76450 | 49.09 | |
| 25 | −86.0400 | (d25) | | | |
| 26 | 102.1700 | 5.0000 | 2.00069 | 25.46 | |
| 27 | −191.1300 | 1.0000 | 1.61396 | 44.29 | |
| 28 | 32.6400 | 5.6100 | | | |
| 29* | −149.4900 | 1.0000 | 1.68948 | 31.02 | |
| 30* | 300.0000 | (BF) | | | |
| Image Surface | ∞ | | | | |

[Aspherical Surface Data]

| | 7th Surface | 24th Surface | 29th Surface | 30th Surface |
|---|---|---|---|---|
| K | 0.00000 | 0.00000 | 0.00000 | 0.00000 |
| A4 | −1.34170E−06 | −2.10140E−06 | −5.97450E−06 | −4.17290E−06 |
| A6 | −7.37970E−10 | −7.28010E−11 | 7.78050E−08 | 7.69700E−08 |
| A8 | −2.08620E−13 | 2.69240E−13 | −1.89690E−10 | −1.63300E−10 |
| A10 | 4.08000E−16 | −5.85700E−16 | 1.46960E−13 | 1.30570E−13 |
| A12 | −9.63930E−19 | 0.00000E+00 | 0.00000E+00 | 0.00000E+00 |
| A14 | 7.18370E−22 | 0.00000E+00 | 0.00000E+00 | 0.00000E+00 |

[Various Data]

| | INF | 832 mm |
|---|---|---|
| Focal Length | 82.63 | 74.71 |
| F-Number | 1.24 | 1.31 |
| Entire Angle of View 2ω | 28.98 | 26.91 |
| Image Height Y | 21.63 | 21.63 |
| Entire Lens Length | 136.91 | 136.91 |

[Variable Distance Data]

| | INF | 832 mm |
|---|---|---|
| d0 | ∞ | 694.8314 |
| d6 | 13.9300 | 7.7100 |
| d8 | 4.1900 | 10.4100 |
| d21 | 8.6500 | 2.2500 |
| d25 | 2.1500 | 8.5500 |
| BF | 17.1880 | 17.1880 |

[Lens Group Data]

| Group | Starting Surface | Focal Length |
|---|---|---|
| G1 | 1 | 227.44 |
| G2 | 7 | 122.50 |
| G3 | 9 | 226.40 |
| G4 | 22 | 78.97 |
| G5 | 26 | −74.63 |

### Numerical Example 3

Unit: mm
[Surface Data]

| Surface Number | r | d | nd | vd | PgF |
|---|---|---|---|---|---|
| Object Surface | ∞ | (d0) | | | |
| 1 | 89.4300 | 4.0500 | 2.00069 | 25.46 | |
| 2 | 179.0700 | (d2) | | | |
| 3 | −311.2700 | 1.0000 | 1.51742 | 52.15 | |
| 4 | 24.6300 | 9.3000 | | | |
| 5* | 70.1600 | 5.4500 | 1.85135 | 40.10 | |
| 6* | −92.0300 | (d6) | | | |
| 7 | −282.0700 | 1.0000 | 1.61340 | 44.27 | |
| 8 | 39.2900 | 7.3200 | | | |
| 9 | −43.7600 | 2.9000 | 1.98612 | 16.48 | 0.6656 |
| 10 | −32.3500 | 1.0000 | 1.84666 | 23.78 | |
| 11 | −217.3900 | 1.0000 | | | |
| 12 (Diaphragm) | ∞ | 1.0000 | | | |
| 13* | 188.1100 | 8.0800 | 1.85135 | 40.10 | |
| 14* | −54.2300 | 0.1500 | | | |
| 15 | 68.3400 | 1.0000 | 1.85451 | 25.15 | |
| 16 | 30.6000 | 14.5200 | 1.59282 | 68.62 | |
| 17 | −71.7300 | (d17) | | | |
| 18 | −102.4800 | 1.0000 | 1.85451 | 25.15 | |
| 19 | 881.3700 | 0.1500 | | | |
| 20* | 49.8300 | 8.5700 | 1.76450 | 49.09 | |
| 21* | −58.1700 | (d21) | | | |
| 22 | 104.8300 | 4.1100 | 1.59282 | 68.62 | |
| 23 | −141.4700 | 0.1500 | | | |
| 24 | 130.1600 | 3.6900 | 1.98612 | 16.48 | |
| 25 | −100.9300 | 1.0000 | 1.78880 | 28.43 | |
| 26 | 26.4400 | 5.7300 | | | |
| 27* | −300.0000 | 1.0000 | 1.85135 | 40.10 | |
| 28* | 300.0000 | (BF) | | | |
| Image Surface | ∞ | | | | |

[Aspherical Surface Data]

| | 5th Surface | 6th Surface | 13th Surface | 14th Surface | 20th Surface |
|---|---|---|---|---|---|
| K | 0.00000 | 0.00000 | 0.00000 | 0.00000 | 0.00000 |
| A4 | −2.93360E−06 | 7.96680E−07 | 1.42910E−06 | 5.39790E−07 | −2.54100E−06 |
| A6 | 1.69060E−09 | −5.74980E−10 | −3.62850E−09 | −1.47780E−09 | −1.74430E−09 |
| A8 | −3.10320E−11 | −2.25210E−11 | 2.61720E−12 | −1.40150E−12 | 2.42580E−12 |
| A10 | 8.02390E−14 | 6.85040E−14 | −7.09200E−16 | 7.08140E−16 | −6.82190E−15 |
| A12 | −5.52680E−17 | −5.97010E−17 | 9.82190E−20 | −7.89460E−19 | 6.27660E−18 |
| A14 | 0.00000E+00 | 0.00000E+00 | 0.00000E+00 | 0.00000E+00 | 0.00000E+00 |

| | 21st Surface | 27th Surface | 28th Surface |
|---|---|---|---|
| K | 0.00000 | 0.00000 | 0.00000 |
| A4 | 3.57670E−06 | 1.33640E−06 | 1.28620E−05 |
| A6 | −4.37050E−09 | −6.01760E−08 | −5.29790E−08 |
| A8 | 4.30360E−12 | 6.01450E−10 | 7.02630E−10 |
| A10 | −5.36930E−15 | −2.73060E−12 | −3.09550E−12 |
| A12 | 3.46920E−18 | 5.34740E−15 | 6.34260E−15 |
| A14 | 0.00000E+00 | −3.78960E−18 | −5.03830E−18 |

[Various Data]

| | INF | 250 mm |
|---|---|---|
| Focal Length | 35.06 | 30.96 |
| F-Number | 1.24 | 1.39 |
| Entire Angle of View 2ω | 62.68 | 62.95 |
| Image Height Y | 21.63 | 21.63 |
| Entire Lens Length | 125.79 | 125.79 |

[Variable Distance Data]

| | INF | 250 mm |
|---|---|---|
| d0 | ∞ | 124.3576 |
| d2 | 11.3600 | 6.7300 |
| d6 | 3.5500 | 8.1800 |
| d17 | 7.8400 | 2.2500 |
| d21 | 2.1500 | 7.7400 |
| BF | 17.7164 | 17.7164 |

[Lens Group Data]

| Group | Starting Surface | Focal Length |
|---|---|---|
| G1 | 1 | 174.58 |
| G2 | 3 | 290.17 |
| G3 | 7 | 86.53 |
| G4 | 18 | 52.77 |
| G5 | 22 | −68.34 |

### Numerical Example 4

Unit: mm
[Surface Data]

| Surface Number | r | d | nd | vd | PgF |
|---|---|---|---|---|---|
| Object Surface | ∞ | (d0) | | | |
| 1 | −136.1200 | 1.0000 | 1.72825 | 28.32 | |
| 2 | 82.1700 | 0.5000 | | | |
| 3 | 61.5800 | 5.4300 | 2.00069 | 25.46 | |
| 4 | −455.3600 | (d4) | | | |
| 5* | 92.3900 | 4.2300 | 1.85135 | 40.10 | |
| 6 | −116.3600 | 1.0000 | 1.67270 | 32.17 | |
| 7 | 99.8700 | (d7) | | | |
| 8 | 225.6600 | 5.6200 | 1.85033 | 42.70 | |
| 9 | −43.3700 | 1.0000 | 1.77047 | 29.74 | |
| 10 | 49.5000 | 4.9100 | | | |
| 11 (Diaphragm) | ∞ | 2.9700 | | | |
| 12 | −85.3300 | 1.0000 | 1.77047 | 29.74 | |
| 13 | 36.1300 | 7.6000 | 1.85033 | 42.70 | |
| 14 | −88.5500 | 0.4000 | | | |
| 15 | −401.3400 | 2.8200 | 1.98612 | 16.48 | 0.6656 |
| 16 | −83.9100 | (d16) | | | |
| 17 | 84.3800 | 3.9900 | 1.80420 | 46.50 | |
| 18 | −145.7300 | 1.0000 | 1.85451 | 25.15 | |
| 19 | 52.0200 | 0.4700 | | | |
| 20* | 40.6000 | 7.6400 | 1.76450 | 49.09 | |
| 21 | −70.2000 | (d21) | | | |
| 22 | 97.4000 | 4.5200 | 2.00069 | 25.46 | |
| 23 | −69.0200 | 1.0000 | 1.67270 | 32.17 | |
| 24 | 26.0800 | 6.1800 | | | |
| 25* | −145.8300 | 1.0000 | 1.68948 | 31.02 | |
| 26* | 300.0000 | (BF) | | | |
| Image Surface | ∞ | | | | |

[Aspherical Surface Data]

| | 5th Surface | 20th Surface | 25th Surface | 26th Surface |
|---|---|---|---|---|
| K | 0.00000 | 0.00000 | 0.00000 | 0.00000 |
| A4 | −3.75770E−06 | −3.63450E−06 | −1.43450E−06 | 5.66650E−06 |
| A6 | −2.66230E−09 | 3.05540E−10 | 1.12700E−08 | 9.37980E−09 |
| A8 | 1.05900E−12 | −3.88710E−12 | −7.16250E−11 | −3.86770E−11 |
| A10 | −9.22860E−16 | 4.23290E−15 | 1.47960E−13 | 1.05560E−13 |
| A12 | 0.00000E+00 | 0.00000E+00 | −1.02230E−16 | −1.16590E−16 |

[Various Data]

| | INF | 394 mm |
|---|---|---|
| Focal Length | 48.89 | 43.77 |
| F-Number | 1.43 | 1.49 |
| Entire Angle of View 2ω | 48.85 | 46.89 |
| Image Height Y | 22.50 | 22.50 |
| Entire Lens Length | 102.43 | 102.43 |

[Variable Distance Data]

| | INF | 394 mm |
|---|---|---|
| d0 | ∞ | 291.8469 |
| d4 | 8.3600 | 2.9200 |
| d7 | 3.5500 | 8.9900 |
| d16 | 6.9000 | 2.2500 |
| d21 | 2.1500 | 6.8000 |
| BF | 17.1875 | 17.1875 |

[Lens Group Data]

| Group | Starting Surface | Focal Length |
|---|---|---|
| G1 | 1 | 228.15 |
| G2 | 5 | 239.99 |
| G3 | 8 | 208.41 |
| G4 | 17 | 46.11 |
| G5 | 22 | −57.78 |

### Numerical Example 5

Unit: mm
[Surface Data]

| Surface Number | r | d | nd | vd | PgF |
|---|---|---|---|---|---|
| Object Surface | ∞ | (d0) | | | |
| 1 | −559.8900 | 1.0000 | 1.48749 | 70.44 | |
| 2 | 30.1500 | 6.6700 | | | |
| 3 | 1228.8800 | 1.0000 | 1.71736 | 29.50 | |
| 4 | 47.7900 | 1.1700 | | | |
| 5 | 43.3200 | 5.3200 | 2.00100 | 29.13 | |
| 6 | −364.9900 | (d6) | | | |
| 7* | 63.0000 | 3.1900 | 1.85135 | 40.10 | |
| 8* | −341.0200 | (d8) | | | |
| 9 | −463.3900 | 2.3700 | 1.98612 | 16.48 | 0.6656 |
| 10 | −88.5600 | 1.0000 | 1.77047 | 29.74 | |
| 11 | 33.5100 | 4.3800 | | | |
| 12 (Diaphragm) | ∞ | 1.6000 | | | |
| 13 | −54831.5600 | 1.0000 | 1.85451 | 25.15 | |
| 14 | 42.1100 | 4.1800 | 1.59282 | 68.62 | |
| 15 | 837.3100 | 0.1500 | | | |
| 16 | 80.2100 | 7.3100 | 1.75500 | 52.32 | |
| 17 | −36.5300 | (d17) | | | |
| 18 | −45.6400 | 1.0000 | 1.78880 | 28.43 | |
| 19 | 46.9600 | 6.7700 | 1.59282 | 68.62 | |
| 20 | −55.8900 | 0.1500 | | | |
| 21* | 50.9800 | 6.8600 | 1.85135 | 40.10 | |
| 22* | −56.7500 | (d22) | | | |
| 23 | −2702.9800 | 2.7400 | 2.00100 | 29.13 | |
| 24 | −93.4800 | 0.1500 | | | |
| 25 | 475.7700 | 1.0000 | 1.77047 | 29.74 | |
| 26 | 20.0200 | 3.3900 | 1.98612 | 16.48 | |
| 27 | 24.4600 | 5.8400 | | | |
| 28* | −261.2200 | 1.5500 | 1.68948 | 31.02 | |
| 29* | 800.0000 | (BF) | | | |
| Image Surface | ∞ | | | | |

[Aspherical Surface Data]

| | 7th Surface | 8th Surface | 21st Surface | 22nd Surface | 28th Surface | 29th Surface |
|---|---|---|---|---|---|---|
| K | 0.00000 | 0.00000 | 0.00000 | 0.00000 | 0.00000 | 0.00000 |
| A4 | −5.30160E−06 | 5.22490E−07 | −4.54930E−06 | −2.34450E−08 | 8.03450E−06 | 2.48730E−05 |
| A6 | −1.20460E−08 | −8.63240E−09 | −1.05650E−09 | −1.32830E−09 | −6.61270E−08 | −5.34120E−08 |
| A8 | 3.20280E−11 | 4.33450E−11 | 8.46400E−13 | 1.63680E−12 | −1.14770E−10 | −1.13960E−10 |
| A10 | −1.96390E−14 | −3.92610E−14 | −1.28810E−15 | −1.62660E−15 | 5.35840E−13 | 7.84630E−13 |
| A12 | 0.00000E+00 | 0.00000E+00 | 0.00000E+00 | 0.00000E+00 | −4.61670E−16 | −9.55320E−16 |

[Various Data]

| | INF | 250 mm |
|---|---|---|
| Focal Length | 33.61 | 30.84 |
| F-Number | 1.44 | 1.52 |
| Entire Angle of View 2ω | 65.06 | 62.48 |
| Image Height Y | 21.63 | 21.63 |
| Entire Lens Length | 105.02 | 105.02 |

[Variable Distance Data]

| | INF | 250 mm |
|---|---|---|
| d0 | ∞ | 145.3819 |
| d6 | 5.9400 | 2.7500 |
| d8 | 3.5500 | 6.7400 |
| d17 | 6.2800 | 2.2500 |
| d22 | 2.1500 | 6.1800 |
| BF | 17.3099 | 17.3099 |

[Lens Group Data]

| Group | Starting Surface | Focal Length |
|---|---|---|
| G1 | 1 | −316.04 |
| G2 | 7 | 62.69 |
| G3 | 9 | 125.19 |
| G4 | 18 | 40.56 |
| G5 | 23 | −51.36 |

### Numerical Example 6

Unit: mm
[Surface Data]

| Surface Number | r | d | nd | vd | PgF |
|---|---|---|---|---|---|
| Object Surface | ∞ | (d0) | | | |
| 1 | 65.4200 | 3.8800 | 1.94594 | 17.98 | |
| 2 | 95.0400 | 0.1500 | | | |
| 3 | 43.4800 | 9.9700 | 1.48749 | 70.44 | |
| 4 | 175.6800 | 0.1500 | | | |
| 5 | 37.3400 | 8.3900 | 1.43700 | 95.10 | |
| 6 | 120.1300 | 1.0000 | 1.84666 | 23.78 | |
| 7 | 31.9900 | (d7) | | | |
| 8* | 42.0300 | 3.6700 | 1.76450 | 49.09 | |
| 9 | 94.1400 | (d9) | | | |
| 10 | 98.4700 | 1.0000 | 1.77047 | 29.74 | |
| 11 | 29.9000 | 6.5200 | | | |
| 12 (Diaphragm) | ∞ | 3.7800 | | | |
| 13 | −70.8000 | 1.0000 | 1.85451 | 25.15 | |
| 14 | 43.6900 | 5.9900 | 2.00100 | 29.13 | |
| 15 | −208.7300 | 0.4000 | | | |
| 16 | 768.8700 | 3.2400 | 1.92286 | 20.88 | 0.6390 |
| 17 | −91.0700 | (d17) | | | |
| 18 | 336.8500 | 1.0000 | 1.84666 | 23.78 | |
| 19 | 91.9600 | 0.3500 | | | |
| 20* | 46.5900 | 7.6100 | 1.59271 | 66.97 | |
| 21* | −51.2200 | (d21) | | | |
| 22 | 73.3100 | 3.2300 | 2.00069 | 25.46 | |
| 23 | −890.4900 | 1.0000 | 1.56732 | 42.84 | |
| 24 | 28.0500 | 9.4600 | | | |
| 25* | −28.9200 | 1.0000 | 1.51633 | 64.06 | |
| 26 | −57.8200 | (BF) | | | |
| Image Surface | ∞ | | | | |

[Aspherical Surface Data]

| | 8th Surface | 20th Surface | 21st Surface | 25th Surface |
|---|---|---|---|---|
| K | 0.00000 | 0.00000 | 0.00000 | 0.00000 |
| A4 | −2.51040E−06 | −4.15030E−06 | −1.27420E−06 | 5.24720E−06 |
| A6 | −2.30330E−09 | 2.12170E−10 | −6.64270E−11 | 5.86390E−09 |
| A8 | −2.87000E−12 | −3.18600E−12 | −4.55090E−12 | −3.61960E−11 |
| A10 | −8.50190E−16 | 5.21900E−15 | 6.58400E−15 | 7.50780E−14 |
| A12 | 0.00000E+00 | 0.00000E+00 | 0.00000E+00 | −1.03400E−16 |

[Various Data]

| | INF | 815 mm |
|---|---|---|
| Focal Length | 83.29 | 73.64 |
| F-Number | 1.46 | 1.51 |
| Entire Angle of View 2ω | 28.78 | 26.35 |
| Image Height Y | 21.63 | 21.63 |
| Entire Lens Length | 110.01 | 110.01 |

[Variable Distance Data]

| | INF | 815 mm |
|---|---|---|
| d0 | ∞ | 705.3250 |
| d7 | 9.1100 | 5.5400 |
| d9 | 2.7400 | 6.3100 |
| d17 | 7.2100 | 2.2500 |
| d21 | 2.1500 | 7.1100 |
| BF | 16.0126 | 16.0126 |

[Lens Group Data]

| Group | Starting Surface | Focal Length |
|---|---|---|
| G1 | 1 | 143.11 |
| G2 | 8 | 96.38 |
| G3 | 10 | −143.89 |
| G4 | 18 | 57.80 |
| G5 | 22 | −69.25 |

[Values Corresponding to Conditional Expressions]

| Conditional | Examples | | | | | |
|---|---|---|---|---|---|---|
| Expressions | EX1 | EX2 | EX3 | EX4 | EX5 | EX6 |
| (1) | 1.36 | 1.24 | 1.26 | 1.34 | 1.40 | 1.27 |
| (2) | 0.047 | 0.039 | 0.047 | 0.047 | 0.047 | 0.028 |
| (3) | 0.0010 | 0.0006 | 0.0005 | 0.0006 | 0.0005 | 0.0005 |
| (4) | 3.7 | 1.6 | 5.5 | 5.2 | 1.5 | 1.7 |
| (5) | 0.017 | 0.019 | 0.031 | 0.020 | 0.022 | 0.010 |
| (6) | 0.84 | 0.64 | 0.84 | 0.70 | 0.83 | 0.02 |
| (7) | 0.023 | 0.025 | 0.010 | 0.011 | 0.035 | 0.018 |

### REFERENCE SIGNS LIST

| | |
|---|---|
| G1 | First lens group |
| G2 | Second lens group |
| G3 | Third lens group |
| G4 | Fourth lens group |
| G5 | Fifth lens group |
| G2asp | Aspherical lens disposed in second lens group G2 |
| | and having such shape as to weaken convex power |
| | from center of optical axis to a periphery |
| Lp | lens disposed in third lens group G3 and having |
| | positive refractive power simultaneously satisfying |
| | conditional expression (2) and conditional expression (3) |
| AL | Air lens formed in fifth lens group G5 and satisfying |
| | conditional expression (6) |
| S | Aperture diaphragm |
| I | Image Surface |

What is claimed is:

1. An optical system comprising, in order from an object side:
a first lens group G1, a second lens group G2 with a positive refractive power, a third lens group G3, a fourth lens group G4 with a positive refractive power, and a fifth lens group G5 with a negative refractive power, wherein,
when focusing from infinity to a close distance, the second lens group G2 and the fourth lens group G4 move to the object side through different paths along an optical axis, the second lens group G2 includes an aspherical lens G2asp having such a shape as to weaken a convex power from a center of the optical axis to a periphery, and the fourth lens group G4 includes one or more lenses each having at least a positive refractive power and one or more lenses each having at least a negative refractive power.

2. The optical system according to claim 1, wherein the fifth lens group G5 satisfies a following conditional expression (1), and the third lens group G3 includes a lens Lp with a positive refractive power simultaneously satisfying following conditional expressions (2) and (3):
1.10<βG5<1.60 (1)
0.021<Lp_ΔPgF<0.055 (2)
1/(Lp_f×Lp_vd)<0.0020 (3)
where
βG5: a lateral magnification of the fifth lens group G5 when focusing on infinity,
Lp_ΔPgF: an anomalous partial dispersion ΔPgF of the lens Lp with the positive refractive power configured to be included in the third lens group G3,
Lp_vd: an abbe number vd of the lens Lp with the positive refractive power configured to be included in the third lens group G3, and
Lp_f: a focal length (mm) of the lens Lp with the positive refractive power configured to be included in the third lens group G3 when not joined.

3. The optical system according to claim 1, wherein following conditional expressions are satisfied:
1.0<f2/f4<6.0 (4)
(f4/vd_G4ave)/f<0.050 (5)
where
f: a focal length (mm) when focusing on infinity,
f2: a focal length (mm) of the second lens group G2 when focusing on infinity, f4: a focal length (mm) of the fourth lens group G4 when focusing on infinity, and
vd_G4ave: an average value of abbe numbers vd of positive lenses included in the fourth lens group G4.

4. The optical system according to claim 1, wherein the fifth lens group G5 includes an air lens AL configured including two adjacent lenses and satisfies the following conditional expression:
−1.00<(R2air+R1air)/(R2air−R1air)<1.00 (6)
where
R1air: an object-side curvature radius (mm) of the air lens AL configured to be included in the fifth lens group G5, and
R2air: an image-side curvature radius (mm) of the air lens AL configured to be included in the fifth lens group G5.

5. The optical system according to claim 1, wherein a following conditional expression is satisfied:
0.005<|(G2aspHnr−G2aspHinf)/f_G2|<0.050 (7)
where
G2aspHinf: a ray height (mm) of an off-axis principal ray at an object side surface of the aspherical lens G2asp when focusing on infinity,
G2aspHnr: a ray height (mm) of the off-axis principal ray at the object side surface of the aspherical lens G2asp when focusing on a closest distance, the off-axis principal ray being a ray passing through a point of intersection of an aperture diaphragm with the optical axis at a largest angle of view, and
f2: a focal length (mm) of the second lens group G2 when focusing on infinity.

6. The optical system according to claim 1, wherein the third lens group G3 includes an aperture diaphragm S.

7. The optical system according to claim 1, wherein the fourth lens group G4 includes an aspherical lens with a positive refractive power.

8. The optical system according to claim 1, wherein the fifth lens group G5 includes an aspherical lens with a negative refractive power on a side thereof closest to an image.
